(19) United States
(12) Patent Application Publication
(10) Pub. No.: US 2020/0131745 A1
(43) Pub. Date: Apr. 30, 2020

(54) MONITORING SYSTEM AND WATER FILTER MAINTENANCE METHOD

(71) Applicant: PANTA RHEI ADVANCED TECHNOLOGIES LTD., Modi'in (IL)

(72) Inventors: Eldad MAZIEL, Mazkeret Batya (IL); Oren GRYFNER, Modi'in (IL)

(21) Appl. No.: 16/493,359

(22) PCT Filed: Mar. 25, 2018
(86) PCT No.: PCT/IL2018/050338

§ 371 Date: Sep. 12, 2019

Related U.S. Application Data
(60) Provisional application No. 62/476,913, filed on Mar. 27, 2017.

(51) Int. Cl. E03B 7/07; G01M 3/28; G01F 1/20; G06Q 10/00

(52) U.S. Cl. CPC E03B 7/072; G06Q 10/20; G01F 1/20; G01M 3/28

(57) ABSTRACT

A water flow measuring device comprises: a) a main body provided with a water flow sensor through which water can flow when demand therefor is made by a water supply system; and, b) data collecting circuitry suitable to collect data generated by said water flow sensor; said water flow sensor being provided with a plugging element coupled with a spring constricting element, which is suitable to block the flow of water therethrough when the water pressure at the inlet of said sensor is smaller than the mechanical pressure applied by said spring constricting element.

### FIELD OF THE INVENTION

The present invention relates to the monitoring and maintenance of water supply systems. More particularly, the invention relates to devices and methods for determining an appropriate time for performing maintenance and/or disposable replacements in a system that dispenses and/or utilizes water.

### BACKGROUND OF THE INVENTION

Systems that utilizes water from an external water source are typically provided with elements adapted to improve the quality of the water employed and, in general, to result in water supply adapted to the intended use. Many kinds of equipment employs such water supply systems, such as drinking water bars, refrigerators that are adapted to dispense cool water and/or ice, washing machines, etc. All such equipment has its own requirement of the water employed, whether for health purposes or in order to maintain a proper functioning of the equipment, e.g., by avoiding excessive deposition of solids from the water. Drinking water bars are very common nowadays both in households and workplaces and, therefore, will be referred to hereinafter as an illustrative example of a system of the invention.

Drinking water bars are commonly provided with two water treatment elements: the first treatment element comprises one or more filters, often including both inner and active materials, such as activated carbon, which are used to remove solid particles as well as chemicals, e.g. chlorine, from the water. The second treatment element comprises means adapted to actively kill bacteria and other pathogens, and typically includes one or more UV lamps. Most drinking water bars are capable of dispensing both hot and cooled water.

Disposables used in a drinking water bar must be periodically replaced because of the decline in their efficacy with use. Filters become clogged and become an impediment to a free flow of water, and moreover they can become overloaded to an extent that they are no longer effective in capturing undesirable chemicals and other agents from the water. UV lamps, on the other hand, need to be replaced according to the number of ignitions.

The problem with which owners of drinking water bars are confronted is that to date there is no efficacious way of knowing what the appropriate time for replacing those disposables is. Since they have to be timely replaced for a correct functioning of the system employing them, manufacturers of such systems dictate replacement schedules that are based on average calculations. However, different users may have very different water usages, and since the need to replace the disposables is dependent on the actual amount of water flowing through the system, the outcome is that disposables are replaced typically too soon (although they may also be replaced too late if the owner is not reminded in time) particularly when additional precaution is practiced by the manufacturer. While this does not present a problem for the manufacturers—and in fact, they derive more profit from this situation since as it is well known profit is primarily made from the disposables—the user is harmed because it has to replace the disposables not according to his actual need and, therefore, must adhere to a wasteful replacement schedule.

There is therefore a need for an efficient way to allow users of systems of this kind to service said, perform maintenance and replace disposables at a time that is commensurate with the actual use made of the system. As stated above, while drinking water bars are good and widespread example of the problem, it exists also with systems such as, for example, refrigerators that are provided with filters that must be replaced, washing machines, etc.

It is an object of the present invention to provide devices that addresses the aforementioned problems. Another object of the present invention is to provide methods for conveniently and efficiently utilize the devices of the invention.

Another object of the invention is to provide devices that can be easily and quickly connected to existing water systems.

Other objects and advantages of the invention will become apparent as the description proceeds.

### SUMMARY OF THE INVENTION

In one aspect the invention relates to a water flow measuring device comprising:
a) a main body provided with a water flow sensor through which water can flow when demand therefor is made by a water supply system;
b) data collecting circuitry suitable to collect data generated by said water flow sensor;
wherein said water flow sensor is provided with a plugging element coupled with a spring constricting element, which is suitable to block the flow of water therethrough when the water pressure at the inlet of said sensor is smaller than the mechanical pressure applied by said spring constricting element.

In an embodiment of the water flow measuring device the plugging element is suitable to actuate a proximity sensor. The proximity sensor can be of a variety of types known to the skilled person which, therefore, are not discussed herein for the sake of brevity. In one exemplary embodiment the proximity sensor is a reed switch and the plugging element is provided with a magnet. In one embodiment the reed switch is a step switch provided with individually identifiable locations suitable to determine the position of the plugging element relative to it.

An efficient embodiment of a water flow measuring device according to the invention is provided with peripheral slots the flow of water through which is blocked when the plugging element does not apply pressure against the spring constricting element. In this embodiment displacement of the plugging element determines the flow rate of water that passes through the sensor.

The device of the invention is designed to generate and output data relative to water usage. Accordingly, the water flow measuring device of the invention is provided with one or more communication components. Such components can be of any suitable type known to the skilled person, for instance, they can be selected from Wi-Fi, Bluetooth and radio.

The invention also encompasses a system for performing maintenance of water dispensing system, comprising:
(i) a water flow measuring device;
(ii) a distance server located on a network; and
(iii) a communication component suitable to transmit data to and from a user.

In one embodiment the network is the Internet. In another embodiment the communication component suitable to transmit data to and from a user includes a portable communication device. Any suitable portable communication device can be utilized in the context of the invention such as, for instance, a smartphone, a tablet, etc.

In another aspect the invention is directed to a method for maintaining a water dispensing system comprising
a) providing data storage means adapted to receive data representative of water usage of said system, said data being generated by a device coupled with, or provided in, said system;
b) correlating said data with a system maintenance need; and
c) providing to a user of said system data relative to said maintenance need.

The invention can satisfy any relevant maintenance need, such as, for instance, the required time of replacement of a disposable. In such case the maintenance need may comprise data adapted to allow the user to select a disposable adapted to the user's specific needs. The method also allows the user to obtain a connection to a supplier of disposables, through which a specific disposable selected according to the user's specific maintenance needs can be obtained.

All the above will be better understood through the following description of exemplary devices, with reference to the appended drawings.

### BRIEF DESCRIPTION OF THE DRAWINGS

In the drawings:

FIG. 1 is an external view of a device according to the invention, installed along an incoming water line;

FIG. 2 is a cross-section of the device of FIG. 1, taken along the AA plane;

FIG. 3 is a cross-section of the device of FIG. 1, taken along the BB plane;

FIG. 4 is an exploded view of the device of FIG. 1;

FIG. 5 is a schematic illustration of a sensor according to one embodiment of the invention;

FIG. 6(a-c) illustrates operating positions of the sensor of FIG. 5; and

FIG. 7 is a schematic illustration of a maintenance system in direct or indirect communication with a device of the invention.

### DETAILED DESCRIPTION OF THE INVENTION

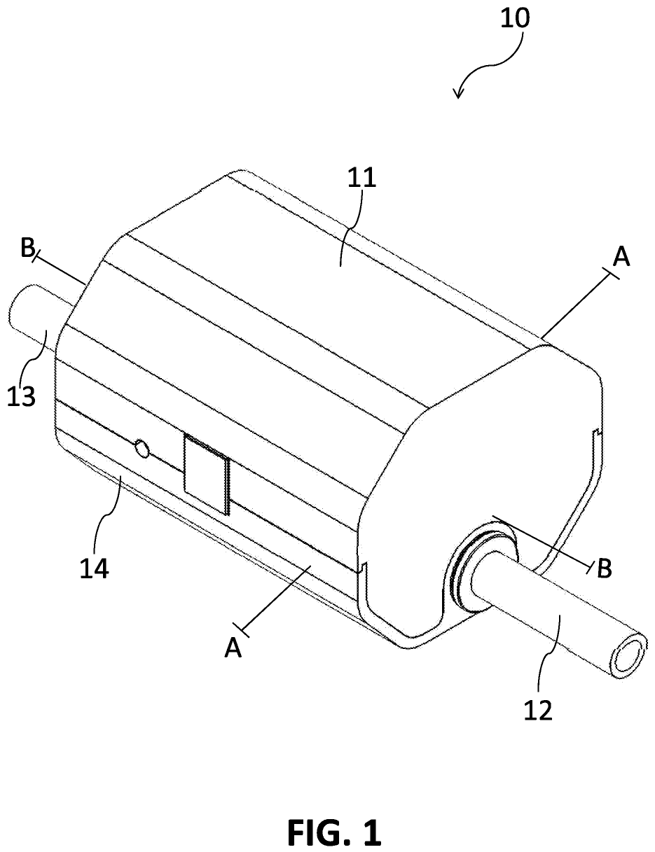

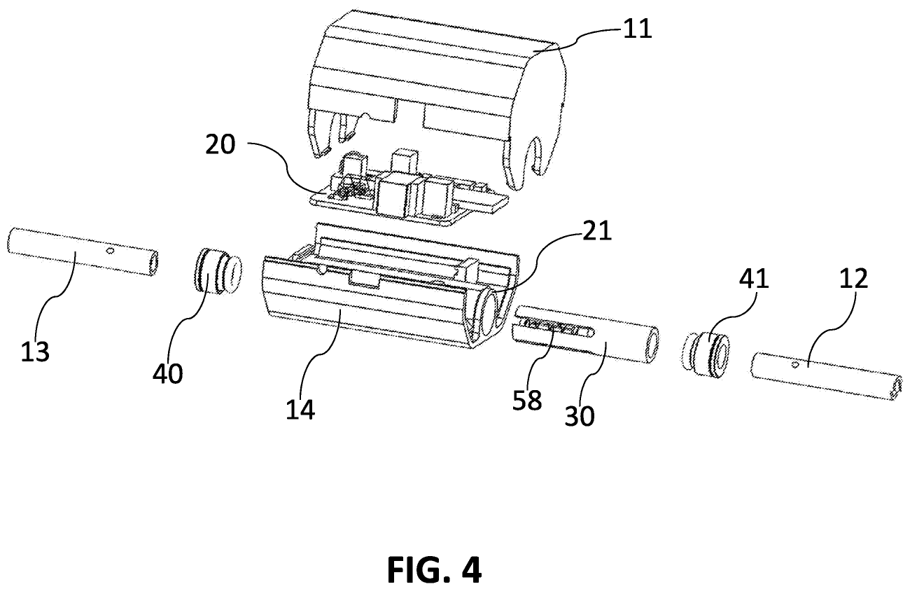

FIG. 1 shows a device of the invention generally indicated by numeral 10, in operative position, with its upper casing 11. Inlet water supply 12 and outlet water supply 13, both shown in truncated views, consists of a single water supply line that has been cut to position a sensor (to be described in detail hereinafter) between the two parts. This situation exists when a device according to the invention has been retrofit to an existing water dispensing system that has an incoming water supply tubing. However, for completely new installations Inlet 12 and outlet 13 may come as separate parts. A bottom portion 14 contains the sensor unit and will be described in greater detail with reference to FIG. 4.

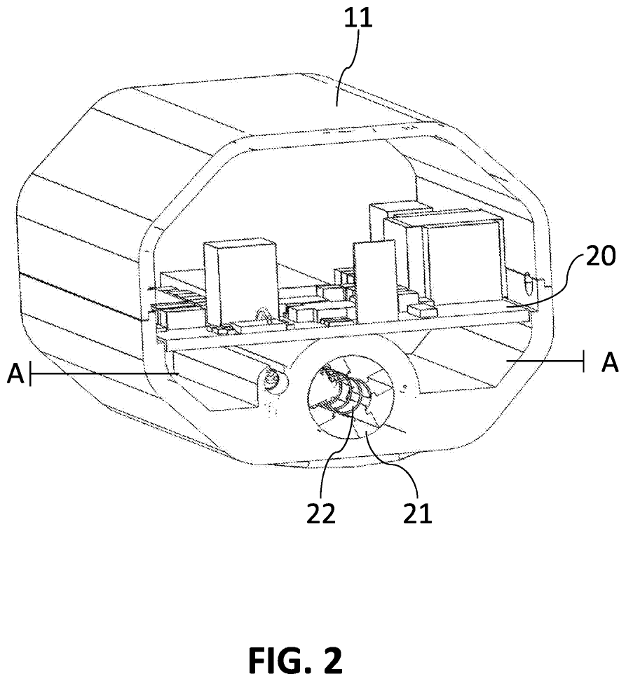

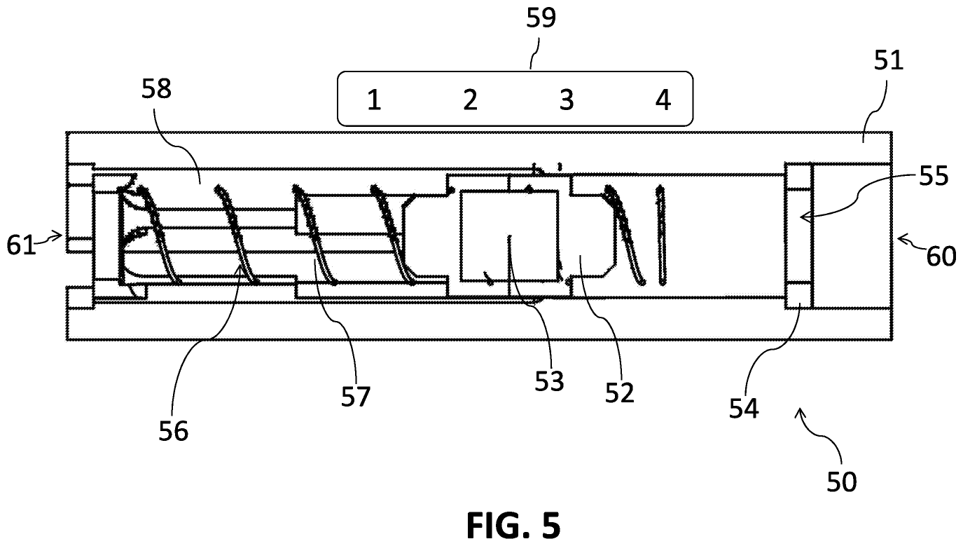

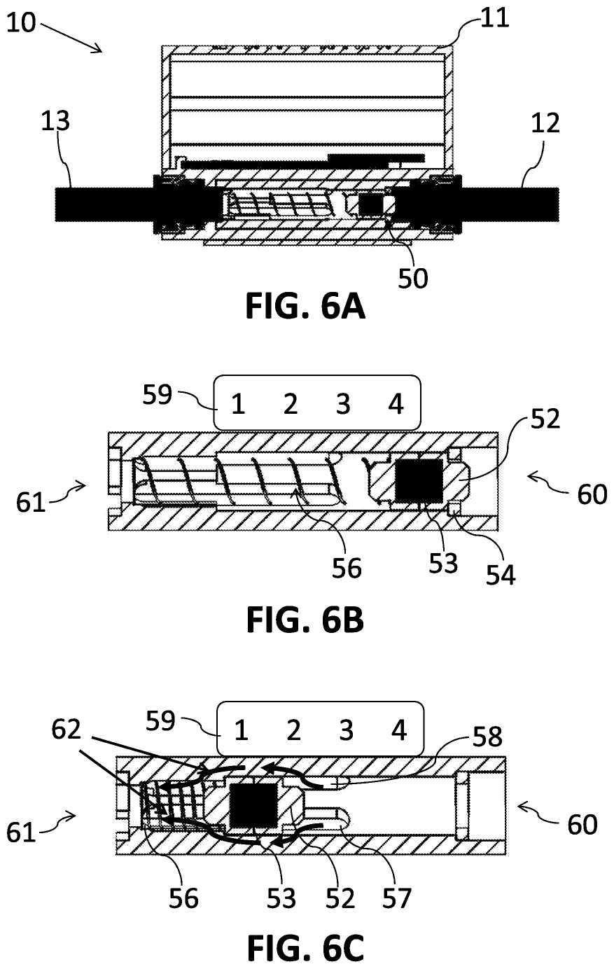

As will be discussed in further detail says the description proceeds, device 10 of FIG. 1 is provided with data processing and with communication means. These may be external, in whole or in part to casing 11 or, as in the case of the device exemplified, maybe contained therein. This is schematically shown in FIG. 2, which is a cross-section of the device of FIG. 1 taken along the AA plane. This cross-section allows to see a circuit board 20, which contains electronic elements suited to perform the tasks that will be discussed further on in this description. Also seen in this figure is a housing 21, adapted to contain outlet water supply tube 13, and a spring number 22 in this figure, that will be described in greater detail with reference to FIG. 5 and FIG. 6.

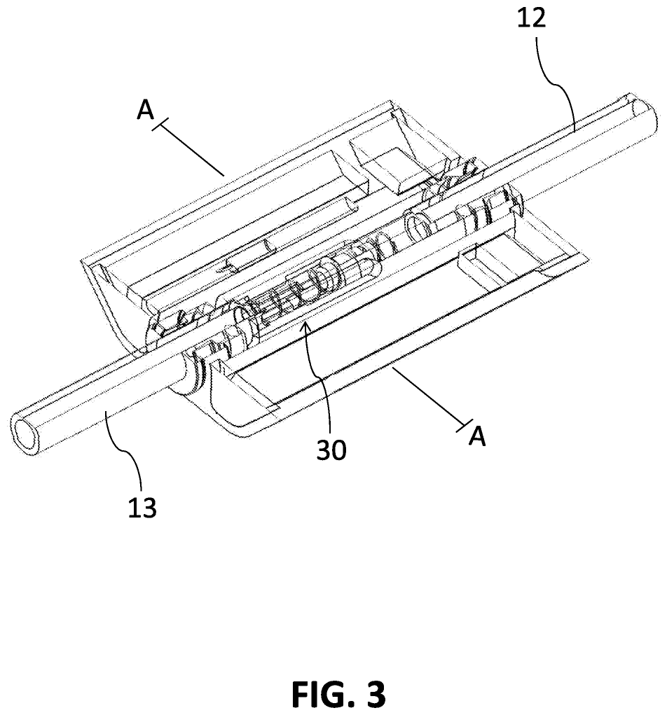

FIG. 3 shows the interiors of device 10 of FIG. 1 with its top removed along the BB plane, so as to show the positioning of water inlet 12 and water outlet 13 on two sides of a sensor assembly partially seen in this figure and generally indicated by numeral 30.

FIG. 4 is an exploded view of the device of FIG. 1. The syndicated in the figures are the same that were used in the description of the previous drawings. Sealing elements 40 and 41 are used to keep inlet and outlet water supply tubes 12 and 13 securely in place. Such sealing elements are conventional in the art and can be of any suitable type and, therefore, they are not described herein in detail.

The positioning of sensor element 30 within housing 21 of bottom casing portion 14 is also illustrated in this figure. The sensor itself will be described with reference to FIGS. 5 and 6.

Looking now at FIG. 5, a sensor 50 according to an embodiment of the invention is illustrated, having a main tubular body 51, eight plug 52 equipped with a magnet 53, a stopper 54, provided with an opening 55 adapted to receive plug 52, a spring 56, peripheral water flow slots 57 and 58 and a reed switch 59. Slot 58 is also shown in FIG. 4. Inlet 60 receives water flowing through Inlet 12 of FIG. 1, and outlet 61 is connected to outlet 13, using connector 41 of FIG. 4. Reed switch 59 is, in this particular embodiment, a four-step switch, but of course different switches with different steps can be used in other embodiments of the invention, not described here for the sake of brevity.

The assembly of switch 50 within device 10 is schematically shown in FIG. 6(a) for orientation purposes only. Its operation will now be illustrated with reference to FIG. 5 and FIGS. 6(b) and (c). FIG. 6(b) shows a situation in which no flow exists, and FIG. 6(c) shows a situation in which water flows to the water dispensing system. In FIG. 6(b) no demand for water is made by the dispensing system and therefore water supply is stopped by an appropriate valve (not shown). As a result, no pressure is applied through Inlet 60 and plug 52 is pushed by spring 56 stopper 54, thereby closing the access to the sensor. In this position magnet 53 is not located in proximity of reed switch 59 and does not affect it.

In FIG. 6(c) a demand for water supply has been made by the machine, thus creating a pressure in Inlet 60 that pushes blood 52 toward spring 56. This movement allows the water to flow through peripheral water flow slots 57 and 58, as indicated by illustrative arrows 62. Magnet 53 is now located in close proximity to reed switch 59, and because this switch is a step switch it signals to the appropriate electronic component located on circuit board 20 of FIG. 2 the extent to which water flow has been permitted. In FIG. 6(c) magnet 53 is located underneath step 1 of reed switch 59, which in this example indicates the highest flow rate. In contrast, FIG. 5 shows a situation in which a lower pressure is applied in the water line, positioning magnet 53 under step 2 of reed switch 59, resulting in a lower flow rate than in FIG. 6(c). Lower pressure on the water supply line may result because of external reasons, but also maybe the result of the clogging of a water filter in the water dispensing system. Accordingly, sensor 50 not only functions to measure the actual flow rate in the water dispensing system at any time, but is also useful in signaling problems occurring within the system itself. For instance, a leakage or flooding of the water system will result in a constant fvlow, which is detected by the device of the invention, thus making it possible to alert the user of the problem, even if he is away from the water system.

Since the replacement of disposables depends on the total amount of water that has passed through the system, the data processing according to the invention takes into account the significance of the location of magnet 53 under the appropriate step of reed switch 59, integrated over time. Typical water dispensing systems have a known factory flow rate, and accordingly the readings of sensor 50 can be automatically calibrated. In cases where such factory flow rate is not known, or where it is suspected that external factors may influence the actual flow rates at the various stages of reed switch 59, a simple calibration procedure can be carried out by dispensing known volumes of water and correlating them with the position of magnet 53 relative to reed switch 59.

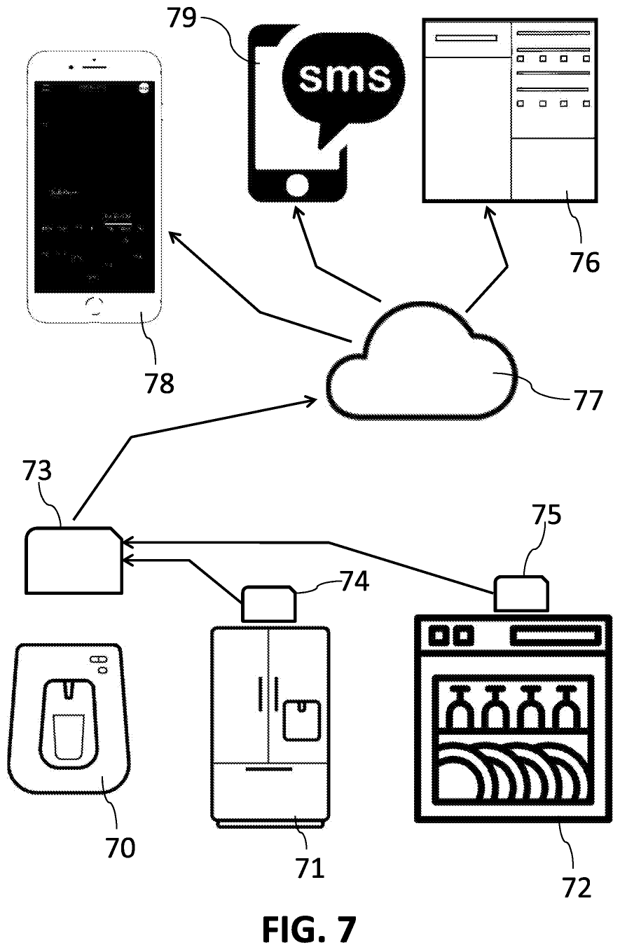

FIG. 7 illustrates the system and process for efficiently maintaining a water supply system according to the invention. In this FIG. 3 representative water dispensing systems are shown: a water bar 70, and refrigerator 71 and a dishwasher 72. These water dispensing systems are provided with devices according to the invention, similar to device 10 of FIG. 1, indicated by numerals 73, 74 and 75, respectively. As explained above, sensor 50 (FIG. 5) generates data indicative of the actual volume of water that flows through the system, which is stored in a memory located on circuit board 20 of FIG. 2, or connected thereto. Devices 73-75 can be provided with either or both of long-range and short-range communication components. Long-range components may include Wi-Fi components suitable to connect to a LAN or WAN, such as the Internet, as well as radio transmitting comonents. Short-range components may typically be Bluetooth communication components.

If devices 73-75 are provided with a long-range component it may deliver the data collected during the use of the water dispensing system to a server 76 located on a network 77. Analysis of the data collected by devices 73-75 is analyzed and stored, according to one embodiment of the invention, in server 76. Such data is then accessible by the user of devices 73-75 via the network, for instance by connecting to server 76 via a portable communication device 78 provided with a suitable app. Server 76 may also actively interact with the user, for instance, by sending text messages, emails, instant messages, etc. to a user mobile communication device 79, as schematically illustrated in the figure. In the context of this description the terms “portable” and “mobile” are used interchangeably.

Other situations may exist in which long range connection is not possible either due to the location of devices 73-75, a malfunctioning of the long-range system, or any other reason. In one embodiment of the invention the device is provided with short-range communication components, such as a Bluetooth component. In such case, if an appropriate app is installed on a portable communication device carried by the user the data collected by devices 73-75 can be transmitted to portable communication device 78, either automatically or upon request by the user, and can then be transmitted by said app to server 76, where it can be stored and manipulated as desired. In a further embodiment of the invention some or all of the data can be analyzed on portable communication device 78 and can be further transmitted to server 76, if and when desired.

The data collected by devices 73-75 will result in the information needed by the user regarding the usage of his disposables and the time when such disposables must be replaced. Information concerning the above, as well as other relevant data pertaining to a monitoring device can be displayed on a portable communication device or on a PC. Such information may include, for instance, the level of water dispensing with time, as well as other information such as pressure drops in the monitored device as discussed above, all of which may assist the user to achieve a better and more efficient maintenance and performance of his monitored devices.

All the above description of embodiments of the invention has been provided for the purpose of illustration and is not meant to limit the invention in any way. As will be appreciated by the skilled person many variations can be performed invention. For instance, the water flow can be monitored by switches other than a reed, switch, data processing and storing components can be located outside the device and in communication there with, and additional sensors can be include, for instance to measure pH and any other parameter of interest, all without exceeding the scope of the invention.

1. A water flow measuring device comprising:
a) a main body provided with a water flow sensor through which water can flow when demand therefor is made by a water supply apparatus;
b) data collecting circuitry suitable to collect data generated by said water flow sensor;
wherein said water flow sensor is provided with a plugging element coupled with a spring constricting element, which is suitable to block the flow of water therethrough when the water pressure at the inlet of said sensor is smaller than the mechanical pressure applied by said spring constricting element.

2. A water flow measuring device according to claim 1, wherein the plugging element is suitable to actuate a proximity sensor.

3. A water flow measuring device according to claim 2, wherein the proximity sensor is a reed switch and the plugging element is provided with a magnet.

4. A water flow measuring device according to claim 3, wherein the reed switch is a step switch provided with individually identifiable locations suitable to determine the position of the plugging element relative to it.

5. A water flow measuring device according to claim 1, characterized in that it is provided with peripheral slots the flow of water through which is blocked when the plugging element does not apply pressure against the spring constricting element.

6. A water flow measuring device according to claim 5, wherein displacement of the plugging element determines the flow rate of water that passes through the sensor.

7. A water flow measuring device according to claim 1, provided with one or more communication components selected from Wi-Fi, Bluetooth and radio.

8. A system for performing maintenance of water dispensing apparatus, comprising:
(i) a water flow measuring device according to claim 1;
(ii) a distance server located on a network; and
(iii) a communication component suitable to transmit to and from a user.

9. A system according to claim 8, wherein the network is the Internet.

10. A system according to claim 8, wherein the communication component includes a portable communication device.

11. A method for maintaining a water dispensing system comprising
a) providing data storage means adapted to receive data representative of water usage of said system, said data being generated by a device coupled with, or provided in, said system;
b) correlating said data with a system maintenance need; and
c) providing to a user of said system data relative to said maintenance need.

12. A method according to claim 11, wherein the maintenance need comprises the required time of replacement of a disposable.

13. A method according to claim 11, wherein the maintenance need comprises data adapted to allow the user to select a disposable adapted to the user's specific needs.

14. A method according to claim 11, further comprising providing the user with a connection to a supplier of disposables through which a specific disposable selected according to the user's specific maintenance needs can be obtained.

15. A method according to claim 11, wherein providing to a user of the system data relative to said maintenance need includes alerting the user of a potential malfunctioning.

16. A method according to claim 15, wherein the potential malfunctioning is a leakage or a flooding of the system.
